(19) United States
(12) Patent Application Publication
(10) Pub. No.: US 2016/0003180 A1
(43) Pub. Date: Jan. 7, 2016

(54) SYSTEM FOR ESTIMATING EXHAUST MANIFOLD TEMPERATURE

(71) Applicants: Michael James MCNULTY, (US); Shree C. KANCHANAVALLY, (US)

(72) Inventors: Michael James McNulty, Lombard, IL (US); Shreecharan Kanchanavally, Naperville, IL (US)

(21) Appl. No.: 14/762,937

(22) PCT Filed: Jan. 24, 2013
(86) PCT No.: PCT/US2013/022846

§ 371 Date: Jul. 23, 2015

(51) Int. Cl. F02D 41/14; F02D 41/00

(52) U.S. Cl. CPC F02D 41/1447; F02D 41/0007

(57) ABSTRACT

A system for estimation of exhaust gas temperature for internal combustion engine at low operating temperatures allows determination of when use of exhaust gas temperature sensor measurements is allowable for engine diagnostic. One approach implements a physical model of pressure and temperature drops across a dual stage waste-gated turbo-charger along with modifiers based on current operating conditions to estimate the temperature in the exhaust manifold. Another models combustion to estimate the temperature in the exhaust manifold.

### BACKGROUND

1. Technical Field

The technical field relates to estimation of exhaust manifold gas temperature for an internal combustion (IC) engine and application of the estimates to vehicle on-board diagnostics.

2. Description of the Technical Field

Exhaust manifold exhaust gas temperature measurements are used in the control of internal combustion engine operation and for diagnostic evaluation of the engine and the exhaust sub-systems. Effective operation of exhaust gas recirculation (EGR) sub-systems used for emissions control depends upon accurate control over EGR mass flow. The determination of EGR mass flow in part depends upon accurate exhaust gas temperature measurement. Common methods for monitoring EGR cooler fouling can be based on the temperature of gas entering the EGR sub-system.

Some current sensors used for Exhaust Manifold Gas Temperature (EMGT or Tₑₘ) have exhibited insufficient resolution at low exhaust temperatures to permit for effective execution of engine control and diagnostics at low exhaust manifold temperatures.

### SUMMARY

Measured pressure and temperature drops across an exhaust turbine, particularly a dual stage exhaust turbine with a waste gate on the high pressure turbine, adjusted for current operating conditions, are used to estimate exhaust gas temperature in the exhaust manifold. Alternatively, adjusted combustion inputs are used to estimate the temperature in the exhaust manifold. Either approach improves accuracy of an exhaust manifold temperature sensor and permits identification of erroneous information from the sensor. It is also possible to eliminate the EGT sensor to reduce costs associated with that sensor and under certain operating conditions to detect a malfunctioning exhaust manifold temperature sensor.

### BRIEF DESCRIPTION OF THE DRAWINGS

FIG. 1 is a schematic diagram of an exemplary engine system.

FIG. 2 is a data flow diagram for determining exhaust manifold temperature.

FIG. 3 is a data flow diagram for determining exhaust manifold temperature based on temperature and pressure drops across an exhaust turbine.

FIG. 4 is a block diagram of a system for determining output error from an exhaust manifold temperature sensor.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

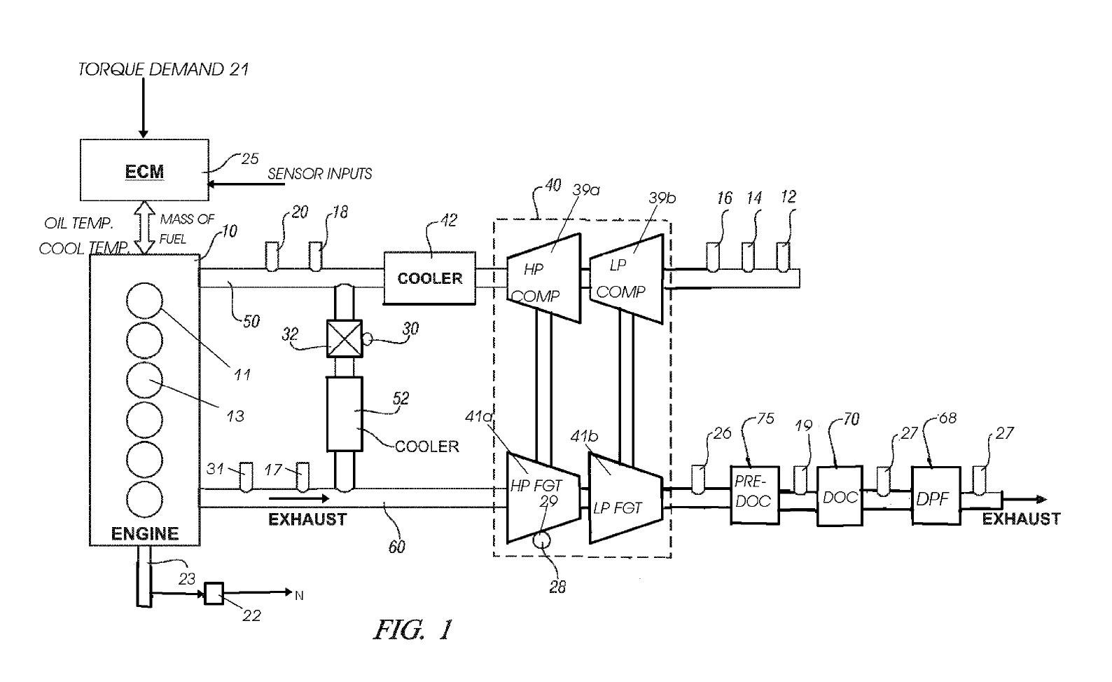

Referring now to the drawings, FIG. 1 depicts an internal combustion (IC) engine 10, associated induction/intake and exhaust systems, and an engine control module (ECM) 25. The exemplary IC engine 10 is a multiple cylinder 11 arrangement and is configured for compression-ignition operation, although the methods disclosed here are not limited to compression-ignition engines. Variable volume combustion chambers 13 are formed in the cylinders 11 between an engine head (not shown) and reciprocating pistons (not shown) that are attached to a crankshaft 23. The associated induction and exhaust systems include an (inter)cooler 42, an exhaust gas recirculation (EGR) valve 32 and recirculated exhaust gas cooler 52, an intake manifold 50, an exhaust manifold and down-pipe 60, and an exhaust after treatment sub-system comprising in downstream order a filter (PRE-DOC filter) 75, a diesel oxidation catalytic converter (DOC) 70 and a diesel particulate filter (DPF) 68.

The induction and exhaust systems also include a dual-stage intake air compressing (turbo-charger) sub-system 40. Dual-stage intake air compressing sub-system 40 comprises high pressure and low pressure fixed geometry exhaust turbines (FGT) 41a, 41b and high and low pressure air compressors (HP COMP/LP COMP) 39a, 39b which are driven by high pressure and low pressure FGT's 41a, 41b, respectively. A dual-stage intake air compressing sub-system 40 based on turbo-charging uses FGT's 41a, 41b to extract energy from the exhaust stream in order to compress air (boost) for delivery to the combustion chambers 13. The dual-stage intake air compressing sub-system 40 can be constructed from superchargers in which case there will be no exhaust turbines and the sub-system becomes exclusively part of the induction system. A waste gate 29 on the high pressure FGT 41a allows control over the amount of energy extracted from the exhaust stream in order to vary the boost to the combustion chambers 13.

The LP COMP 39b draws intake air at near ambient pressure and temperature and compresses the air for the second stage HP COMP 39a. HP COMP 39a forces air under pressure into the intake manifold 50 through an (inter)cooler 42. Delivering air at greater than ambient pressure to combustion chambers 13 increases the air mass in the combustion chambers over a naturally aspirated engine and thereby allows more fuel to be injected. Increased amounts of energy are released with each combustion cycle resulting in the increased output of mechanical power. Thermodynamic law predicts that the extraction of energy from the exhaust stream will reduce the temperature of the exhaust stream moving downstream from the exhaust manifold 60 to discharge from the LP FGT 4 lb. A portion of the exhaust gas stream is forced from the exhaust manifold 60 through the EGR valve 32 to the intake manifold 50 since the pressure in the exhaust manifold is higher than the pressure in the intake manifold.

Various sensors may be installed on the IC engine 10 or associated with the various sub-systems to monitor physical variables and generate signals which may be correlated to engine 10 operation and ambient conditions. The sensors include an ambient air pressure sensor 12, an ambient or intake air temperature sensor 14, and an intake air mass flow sensor 16, all which can be configured individually or as a single integrated device. In addition there are an intake manifold air temperature sensor 18, and an intake manifold pressure sensor 20. Additional sensors may include an FGT waste gate duty cycle sensor 28 and an EGR valve position sensor 30. A tachometer 22 monitors rotational speed in revolutions per minute (N) of the crankshaft 23. Engine speed (N) may be derived from a cam shaft position sensor (not shown) in the absence of a crankshaft associated tachometer 22. An exhaust manifold temperature sensor 31 and an exhaust manifold pressure sensor 17 may be located in physical communication with the exhaust manifold 60. A post low pressure fixed geometry turbine (LP FGT) pressure sensor 26 measures pressure of the exhaust gas upon discharge from the low pressure FGT 41b. A pressure difference sensor 27 measures pressure drop across the DPF 68. A temperature sensor 19 provides exhaust gas temperature after discharge from the PRE-DOC filter 75. The present disclosure outlines methods for the estimation of gas temperature in the exhaust manifold based on particular sets of sensors to supplement or replace exhaust manifold temperature sensor 31. The enumeration of the various sensors does not mean all are present on every vehicle or that others might not be present. Data links of various types (not shown) may be used to connect sensor readings to the ECM 25.

ECM 25 receives engine oil and engine coolant temperature measurements from IC engine 10 sensors (not shown). Torque demand 21 is a function of driver pedal position. Engine speed (N) and torque demand 21 are used to determine torque (R). Friction losses depend upon engine speed (N).

The readings from the sensors, where present, represent several operating variables, including: Tᵢₘ—intake manifold temperature from sensor 18; Pᵢₘ—intake manifold pressure from sensor 20; Tₐₘ—ambient temperature from intake air temperature sensor 14; Pₐₘ—ambient pressure from ambient air pressure sensor 12; WGTₚ—high pressure FGT 41a waste gate 29 position from waste gate duty cycle sensor 28; EGVₚ—EGR valve 32 position from sensor 30; N engine speed from tachometer 22; Pₑₘ—exhaust manifold pressure from exhaust manifold pressure sensor 17; Pₐₜ—exhaust pressure upon discharge from LP FGT 41b from post LP FGT pressure sensor 26; P_{pc}—pressure change across the DPF 68 from DPF pressure difference sensor 27, this value may be used to determine pressure at the outlet from the LP FGT 41b assuming pressure drop across the PRE-DOC 75 and DOC 70 are negligible; and, T_{pc}—exhaust gas temperature after discharge from the PRE-DOC 75 comes from a temperature sensor 19. An exhaust manifold temperature sensor 31 generating a measured value Tₑₘ for exhaust gas temperature in the exhaust manifold 60.

Values for other variables may be derived or inferred. M′ᵢₘ—is the mass rate of gas aspired by the IC engine 10 is the sum of the intake air mass flow measured by sensor 16 and the mass flow of recirculated exhaust gas through EGR valve 32. Tₐₜ—is exhaust temperature upon discharge from LP FGT 41b and may be estimated from T_{pc}, Pₐₜ, Pₑₘ and WGTₚ. R—is torque which is returned by a table look up operation within ECM 25 in response to the torque demand signal 21 and engine speed (N). Fuel mass flow M′_{fuel} is known by ECM 25 through control over fuel injectors (not shown) for variable volume combustion chambers 13. M′ is the mass flow rate of the exhaust gas and is the sum of aspired gas mass flow M′ᵢₘ and fuel mass flow M′_{fuel}. Specific heat cₚ for M′ is a function of the relative proportions of the constituents of aspired gas mass flow M′ᵢₘ and fuel mass M′_{fuel}. Isentropic efficiency of the exhaust turbine arrangement 41 is adjusted for the duty cycle of the waste gate (WGTₚ).

The ECM 25 is an element of an overall vehicle control system and may be part of a distributed control architecture operable to provide coordinated system control. ECM 25 operates on inputs from the aforementioned sensing devices, and execute algorithms to control various actuators to achieve control targets, including fuel economy, emissions, performance, drive-ability, and diagnose and protect hardware. The ECM 25 may be a general-purpose digital computer such as generally comprises a microprocessor or central processing unit, storage mediums comprising read only memory (ROM), random access memory (RAM), electrically programmable read only memory (EPROM) or some other non-volatile memory element, high speed clock, analog to digital (A/D) and digital to analog (D/A) circuitry, and input/output circuitry and devices (I/O) and appropriate signal conditioning and buffer circuitry.

Generally a set of control algorithms, comprising resident program instructions and calibrations, can be stored in ROM or EPROM and executed to provide the respective functions. Algorithms are typically executed during preset loop cycles such that each algorithm is executed at least once each loop cycle. Algorithms stored in the non-volatile memory devices are executed by one of the central processing units and are operable to monitor inputs from the sensing devices and execute control and diagnostic routines to control operation of the respective device, using predetermined calibrations. Loop cycles are typically executed at regular intervals during ongoing engine and vehicle operation. Alternatively, algorithms may be executed in response to occurrence of an event.

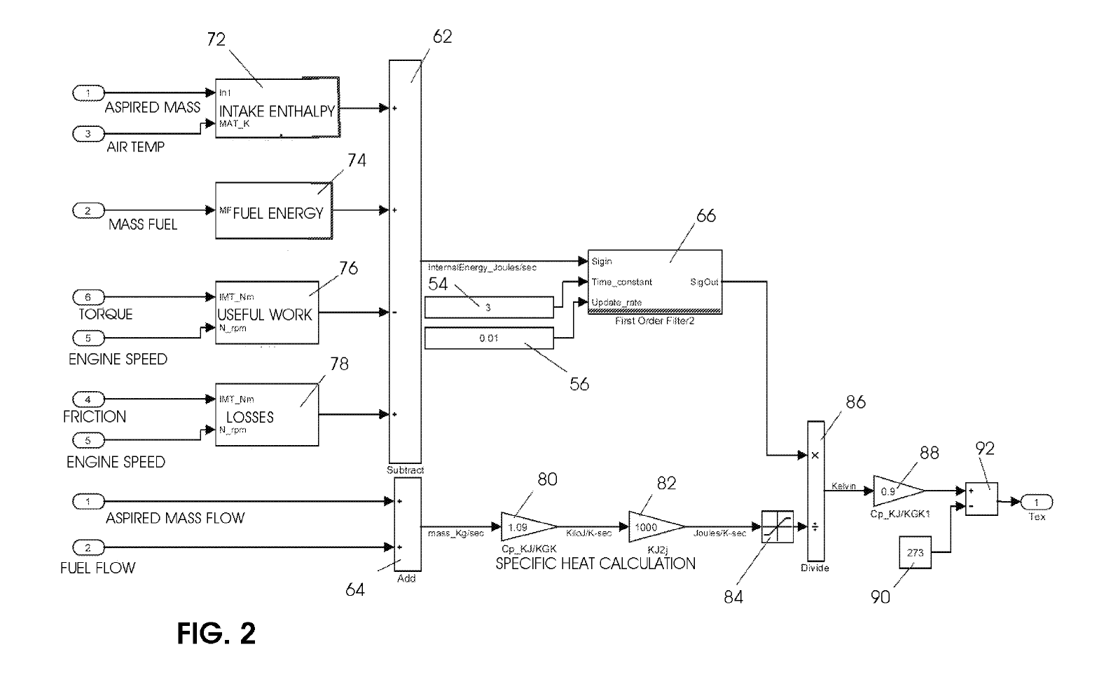

Referring now to FIG. 2, implementation of a combustion model for exhaust gas temperature estimation is discussed. The combustion model is based on the first law of thermodynamics and can be expressed in terms of an energy balance equation as follows:

Tₑₘ=(Q′_{gas}+Q′_{fuel}−Q′_{work}+Q′ₗₒₛₛₑₛ)/M′cₚ (1)

Where: Tₑₘ is exhaust manifold temperature; Q′_{gas} is the enthalpy of the aspired gas mass flow; Q′_{fuel} is fuel energy; Q′_{work} is work done during the combustion process; Q′ₗₒₛₛₑₛ represents losses including those due to friction and heat loss from the variable volume combustion chambers 13. As defined above, M′ is the exhaust mass flow from the engine; and cₚ is the specific heat at constant pressure of the combustion product. Proxy values for all of the input variables on the right hand side of the equation can be determined from sensor measurements or values derived from sensor measurements. Heat loss from the variable volume combustion chambers 13 can be modeled under steady state operating conditions using ambient temperature and engine coolant or engine oil temperature.

Data flow relative to the ECM 25 resolves to the six input variables. The input variables are fuel mass flow, aspired gas mass flow, engine speed, torque demand, intake manifold air temperature and a factor relating to estimated mechanical and heat losses as explained above. Fuel flow M′_{fuel} is determined by ECM 25. The aspired mass flow M′ᵢₘ, engine speed N, intake manifold air temperature Tᵢₘ are determined from sensor measurements. Output torque R and friction losses are generated by a table look up operation within ECM 25 using torque demand and engine speed N.

Solution of Equation (1) by ECM 25 is not direct as the available data does not provide a one to one match to the equation. Proxies are identified for both the numerator/dividend and denominator/divisor of equation (1). The dividend is obtained by multiplying aspired mass flow M′ᵢₘ and intake temperature Tᵢₘ to determine intake enthalpy Q′ᵢₘ (step 72). The quantity of fuel of a known type will have a known energy content Q_{fuel} (step 74). Useful work Q′_{work} is the product of torque R and engine speed N (step 76). Work lost Q′ₗₒₛₛₑₛ is torque reduced overcome friction multiplied by engine speed (step 78). These values are summed (operation 62) and filtered (operation 66 using time constant 54 and update rate 56) to produce the dividend.

The divisor is the product of mass flow rate of the exhaust by-product M′ multiplied by the specific heat cₚ of the exhaust by-product. M′ is obtained by addition of aspired gas mass flow and fuel mass flow (operation 64). The units of the result of the division carried out in step 86 is rescaled from degrees Kelvin to degrees Celsius in steps 88, 90 and 92.

An alternative method of estimating exhaust manifold temperature relies on pressure changes across the exhaust turbine, temperature of the exhaust gas upon discharge from the exhaust turbine, and an estimate of isentropic efficiency of the turbine. A different set of measured sensor outputs and derived variables are used than are used with Equation (1). The variables used are: T_{pc}—post PRE-DOC filter 75 temperature from temperature sensor 19; N—engine RPM; R—torque; Pₐₜ—exhaust gas pressure upon discharge from the LP FGT 41b; Pₑₘ—exhaust manifold pressure from pressure sensor 17; WGTₚ—the waste gate duty cycle from waste gate duty cycle sensor 28; M′ᵢₘ—aspired mass flow; gamma (γ)—ratio of specific heat at constant pressure to specific heat at constant volume; eta (ε)—isentropic efficiency of the fixed geometry exhaust turbine 41a, 41b (this varies with pressure ratio across the turbine and mass flow through the turbine, and can be approximated from empirical data and the output of the waste gate duty cycle sensor 28); and Tₐₜ—post turbine temperature data derived from an empirically derived relationship Tₐₜ and T_{pc}.

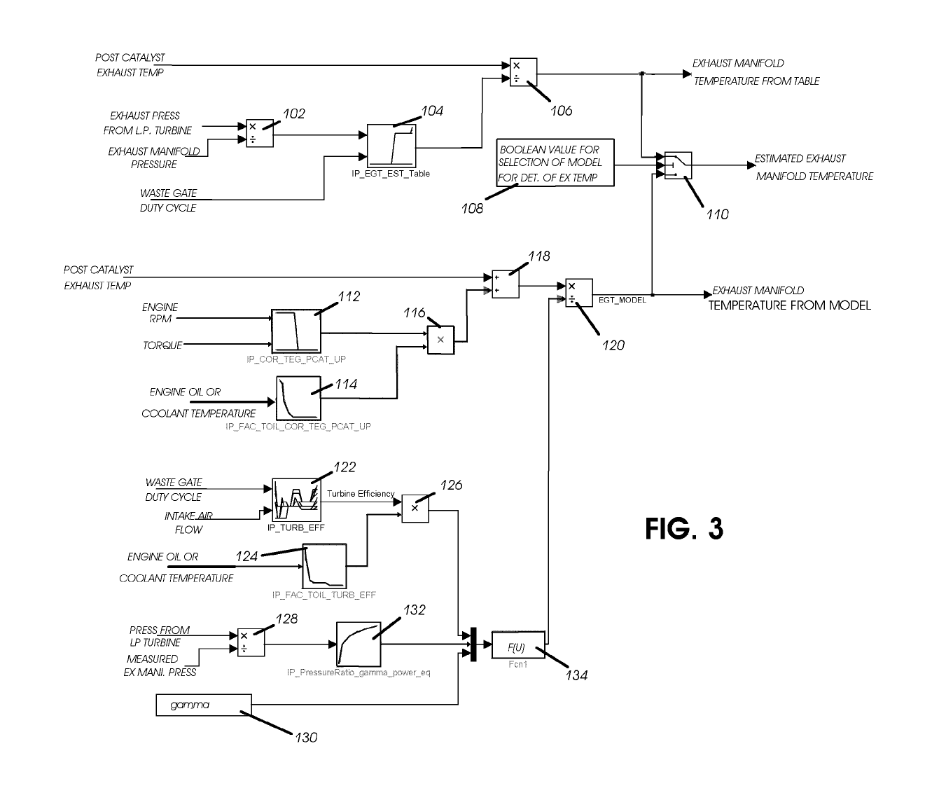

FIG. 3 embodies the steps for estimating exhaust manifold temperature using measured pressure change across the FGT 41. The methods are implementations of the energy balance equation:

Tₑₘ=Tₐₜ/(1+ε((Pₐₜ/Pₑₘ)^{((γ-1)/γ)-1}) (2)

Gamma (γ) can be based on empirical background data which varies with exhaust gas temperature. In the operating range prevalent here gamma is treated as a constant.

One approach to implementation of Equation (2) based on one available data set (post catalyst exhaust gas temperature T_{pc}, exhaust pressure Pₐₜ after the low pressure FGT 41b, exhaust pressure in the exhaust manifold Pₑₘ, and the waste gate duty cycle WGTₚ. The approach is partially based on empirically derived look up tables.

At step 102 the ratio of exhaust gas pressure (Pₐₜ) upon discharge from the LP FGT 41b to exhaust manifold pressure (Pₑₘ) is determined. This value should always be less than or equal to one. The ratio of pressures is supplied to step 104 along with WGTₚ (waste gate duty cycle) as inputs to a look up table. The baseline efficiency of the FGT 41 is reduced by a factor relating to WGTₚ. The LUT accessed in step 104 returns a dimensionless adjustment factor which is divided into measured post catalytic temperature T_{pc} (step 106) to generate an estimate of exhaust manifold temperature Tₑₘ or Tₑₘ₋ₑₛₜ. Tₑₘ₋ₑₛₜ is passed to a selection operation 110.

In order to account for various heat losses occurring between turbine outlet port and post catalytic outlet port an estimation method is based on engine operating conditions and engine coolant condition. Engine speed N and torque R setpoints are used as inputs to a table (operational step 112) which returns a unit less engine temperature correction factor (COR_TEG). In parallel the engine oil temperature or engine coolant temperature are applied as inputs to another look-up table (step 114) to generate estimated turbine outlet exhaust gas temperature. The correction factor is multiplied (step 116) with engine temperature to generate an adjusted correction factor which is added (step 118) to the post catalyst exhaust gas temperature T_{pc} (step 118) to account for the heat losses. This result is applied as the dividend to operation 120.

The divisor for operation 120 is produced from multiple variable inputs. Operation 122 compares the waste gate duty cycle with intake air mass flow from sensor 16 to produce a turbine efficiency value. Operation 124 accounts for turbine efficiency changes due to changing engine operating temperature (cold, warm or hot). Engine operating temperature is indicated by the current measured engine coolant or engine oil temperature. The result of the multiplication of the outputs of steps 122 and 124 is related to turbine isentropic efficiency (eta (ε)).

Steps 128 and 132 represent another table look up operation based on the ratio of the pressure change from the exhaust manifold 60 to the exhaust port from the low pressure FGT 41b. The table approximates the power function (pressure ratio)̂(gamma-1/gamma) Gamma is assumed to be constant in this approximation.

Step 130 represents input of the value for gamma. The divisor for equation (2) is generated at step 134 by combination of the output of operation 126 with either the output of 132 or 130. This value is applied as the divisor input to step 120.

Operational step 110 is selection of the output of operation 120 or operation 106 based on a Boolean value from block 108. Here the manufacture can provide a value (1 or 0) to choose between the methods depending upon the sensors available.

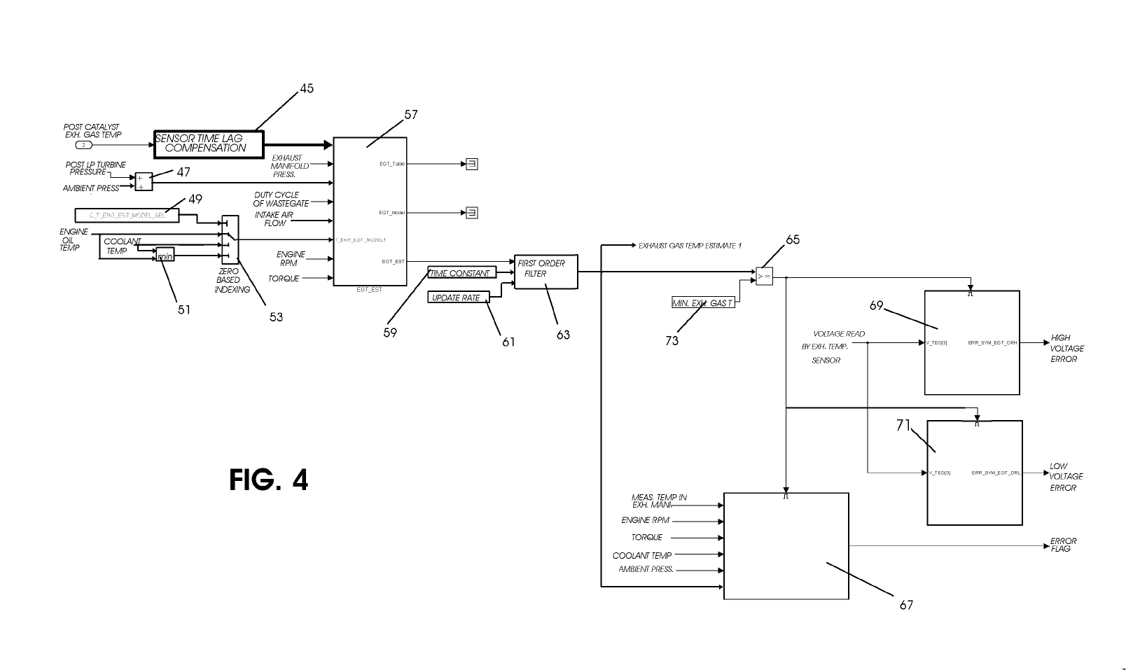

FIG. 4 relates to error detection for an exhaust manifold temperature sensor 31. As noted in relation to FIG. 1, provision is often made in vehicle exhaust systems for an exhaust manifold temperature sensor 31, but that under certain engine operating conditions, particularly low operating temperatures such sensors may be prone to substantial error. In FIG. 4 an exhaust manifold exhaust gas temperature estimation operation is represented by block 57. Exhaust manifold exhaust gas temperature estimation block 57, as described above, can operate on a plurality of inputs. A variety of models can be employed for error detection and accordingly several variable inputs are shown to block 57. These include: post PRE-DOC exhaust gas temperature from temperature sensor 19 (which is shown with sensor time lag compensation constant 45); the value from a summer 47 which combines readings from the post LP FGT pressure sensor 26 and ambient pressure sensor 12; exhaust manifold pressure; the duty cycle of the waste-gate; intake air mass flow from sensor 16; a selected one (zero-based index selection step 53 based on Boolean select value 49) of engine temperature proxies including engine oil temperature, engine coolant temperature or the minimum (comparison step 51) of coolant and oil temperatures; engine speed N; and, engine torque R. The exhaust gas temperature estimate is subject to first order filtering (step 63) based on a given time constant (59) and a given update rate (61).

The output from filter 63 is a moving average of estimated exhaust gas temperature in the exhaust manifold 60. This result is to enable detection of possible error conditions. The moving average is applied to a comparator 65 which compares the moving average of estimated exhaust gas temperature to a value for the minimum exhaust gas temperature 73 at which an exhaust manifold temperature sensor 31 is expected to produce accurate readings. When the moving average estimated exhaust gas temperature equals or exceeds the minimum value supplied exhaust manifold temperature sensor the comparator 65 applies an enable signal to error detection tests 67, 69 and 71.

An out of range error detection test 67 receives the moving average estimate, the instantaneous temperature measurement from the exhaust manifold temperature sensor 31, engine speed, engine torque, engine coolant temperature and ambient pressure as inputs. An error flag is generated if instantaneous measured temperature varies from the moving average estimated temperature by more than a predetermined allowable range. The predetermined allowable range varies depending upon vehicle operating conditions. Vehicle operating conditions are characterized in terms of engine speed, torque, engine coolant (or oil) temperature and ambient pressure and are related to the load the engine is under or to extreme operating conditions such as unusually cold outside temperatures (which can be expected to be reflected in low coolant temperatures).

High and low voltage error detection test blocks 69 and 71 compare the raw voltage reading from an exhaust manifold temperature sensor 31 to operational boundary conditions to determine possible high and low voltage errors, respectively, or if the readings are stuck. High and low voltage error signals can result.

What is claimed is:

1. An apparatus for estimating exhaust gas temperature from an internal combustion engine having an exhaust system, an induction system and an exhaust gas recirculation system, the apparatus comprising:
a plurality of engine sensors providing values for operating variables of the internal combustion engine, a plurality of exhaust system sensors providing values for operating variables of the exhaust system, a plurality of induction system sensors providing values for operating variables of the induction system and at least a first sensor providing values for an operating variable relating to operation of the exhaust gas recirculation system;
a source of a torque demand signal; and
data processing means connected to receive data from the engine sensors, the induction system sensors, the exhaust system sensors, the at least first sensor for the exhaust gas recirculation system and the torque demand signal, providing for selection from at least two differentiated sets of sensors from which to calculate estimates of gas temperature in an exhaust manifold for the exhaust system and providing the estimates.

2. The apparatus according to claim 1, wherein a set of sensors is selected to implement a combustion model for exhaust gas temperature.

3. The apparatus according to claim 2, further comprising:
the set of sensors selected to implement the combustion model includes sensors for measuring intake air mass flow sensor and a sensor relating to measurements of recirculated exhaust gas mass flow from which to sum aspired gas mass flow by the internal combustion engine.

4. The apparatus according claim 1, further comprising:
an exhaust turbine including a waste gate in the exhaust system;
a compressor in the induction system coupled to be driven by the exhaust turbine;
exhaust system pressure sensors for generating pressure readings for the exhaust manifold and downstream from the exhaust turbine; and
a temperature sensor for generating exhaust gas temperature readings downstream from the exhaust turbine.

5. The apparatus according to claim 4, further comprising:
a set of exhaust system sensors including the first and second exhaust system pressure sensors, the temperature sensor for generating exhaust gas temperature readings downstream from the exhaust turbine and a waste gate position sensor; and
the data processing means providing for operating on readings from the set of exhaust system sensors for generating an estimate of exhaust gas temperature in the exhaust manifold.

6. The apparatus according to claim 1, further comprising:
an exhaust turbine including a waste gate fluidically connected to the exhaust manifold;
a compressor in the induction system coupled to be mechanically driven by the exhaust turbine;
first and second exhaust system pressure sensors for generating pressure readings in the exhaust manifold and at a point of discharge from the exhaust turbine; and
a source of engine temperature;
a sensor indicating duty cycle of the waste gate;
an exhaust system temperature sensor downstream from the exhaust turbine;
an intake air mass flow sensor system;
a source of speed measurements for the internal combustion engine;
a source for gamma;
a source of a torque demand measurement; and
the data processing means being responsive to the pressure readings from the first and second exhaust system pressure sensors, engine temperature, the waste gate duty cycle, intake air mass flow, exhaust system temperature, engine speed, torque demand and gamma for estimating exhaust manifold temperature.

7. The apparatus according to claim 6, further comprising:
the data processing means being responsive to estimation of exhaust gas temperature for indicating over fueling or under fueling of the internal combustion engine.

8. The apparatus according to claim 2, further comprising:
an exhaust manifold temperature sensor for measuring exhaust gas temperature in the exhaust manifold;
a source of a minimum threshold representing a minimum temperature for operation of the temperature sensor for reading exhaust gas temperature;
comparator means for comparing the estimate of exhaust gas temperature against the minimum threshold and generating an enable signal when the estimate of exhaust gas temperature exceeds the minimum threshold; and
means responsive to presence of the enable signal for comparing the estimate of exhaust gas temperature with measured exhaust gas temperature and generating an error flag if a difference exceeds a limit range.

9. The apparatus according to claim 8, wherein the means for comparing receives input signals relating to internal combustion engine operating conditions and in response there varies the limit range.

10. The apparatus according to claim 9, further comprising:
high and low voltage sensors enabled by presence of the enable signals and connected to receive a raw voltage signal from the exhaust manifold temperature sensor for indicating high and low voltage error conditions.

11. A method for estimating exhaust gas temperature from an internal combustion engine having an exhaust system, an induction system and an exhaust gas recirculation system, the method comprising the steps of:
providing readings for a plurality of operating variables of the internal combustion engine, a plurality of exhaust system operating variables relating to the exhaust system, a plurality of operating variables relating to the induction system and at least a first operating variable relating to operation of the exhaust gas recirculation system;
providing a torque demand signal;
selecting one set from at least two differentiated sets of readings; and
estimating gas temperature in an exhaust manifold for the exhaust system on the basis of the selected set.

12. The method according to claim 11, wherein the at least two differentiated sets of readings relate respectively to a combustion model and to a pressure change across and exhaust turbine model.
